(19) United States
(12) Patent Application Publication
(10) Pub. No.: US 2017/0204016 A1
(43) Pub. Date: Jul. 20, 2017

(54) Manufacturing Process And Products Of Synthetic Gypsum Fertilizer With Decreased Dissolution or Solubility Profile

(71) Applicant: Gypsoil Pelletized Products, Chicago, IL (US)

(72) Inventor: Steve Musser, Pomeroy, OH (US)

(73) Assignee: Gypsoil Pelletized Products, Chicago, IL (US)

(21) Appl. No.: 15/408,384

(22) Filed: Jan. 17, 2017

Related U.S. Application Data
(60) Provisional application No. 62/279,576, filed on Jan. 15, 2016.

(51) Int. Cl. C05D 3/00; C01F 11/46

(52) U.S. Cl. CPC C05D 3/00; C01F 11/46

(57) ABSTRACT

A manufacturing process for producing pelletized synthetic gypsum with desirable durability and dissolution/solubility properties. Raw synthetic gypsum with about 8-12% of water by weight is mixed with a binder comprising at least one polysaccharide or biogum. In a first stage, the process produces pellets by compaction to form from a mixture of the raw synthetic gypsum and the binder. At that point, the pellets have 9-12% of water by weight. In a second stage and without adding water between the first stage and the second stage, the pellets are further compacted in a tumbler or spheronizor. Next, the pellets are dried to remove moisture from the pellets. The dried pellets include less than 1% water by weight.

### CROSS-REFERENCE OF RELATED APPLICATION

This is a US nonprovisional application of the US provisional patent application, Ser. No. 62/279,576, filed on Jan. 15, 2016. The entire disclosure of the above-referenced provisional application is incorporated by reference herein.

### BACKGROUND

Gypsum has long been used as a source of sulfur and calcium for growing crops. Granulated gypsum from mined sources has been widely available for decades. In recent years, large amounts of gypsum produced by utilities have become available for agriculture as a result of the flue gas desulfurization process, producing so-called synthetic gypsum or flue-gas desulfurization (FGD) gypsum (collectively referred to as synthetic gypsum below), which became popular for coal-fired power plants after passage of the 1990 Clean Air Act. In 2004, the Ohio State University estimated that at least 12 million tons of this highly pure gypsum are produced in the US annually. The FGD gypsum is a powder with typical particle sizes of 200-300 microns. The powder has a typical moisture content of 8-12% water upon leaving the power plant.

In terms of solubility, all currently available synthetic gypsum fertilizers behave like mined gypsum, in other words, they dissolve almost instantaneously upon contact with water. Firms are successfully marketing a granulated gypsum pellet from synthetic gypsum with these properties. While solubility is necessary for soil absorption, and ultimately for crop nutrient uptake, the ready solubility of many commercial fertilizers plays a significant role in nutrient runoff, and therefore, water pollution.

However, when attempting to pelletize synthetic gypsum, firms discovered that the synthetic gypsum forms quite differently than the typical mined gypsum. At the same time, these firms have only focused on producing a pellet durable enough to be blended and spread with other common fertilizers. No effort has been made to significantly alter the in-field performance of the fertilizer itself. Like most other modern fertilizers, gypsum is soluble in water.

Consequently, these firms use conventional manufacturing techniques to pelletize gypsum using either a calcium lignosulfonate or an ammonium lignosulfonate binder to achieve a product that is hard enough to blend with other commercial fertilizers. The single design variable appears to have been crush strength or another metric of fertilizer durability.

### SUMMARY

Embodiments of this invention overcome deficiencies of the prior art by using an innovative manufacturing and production process to produce an improved FGD gypsum with superior durability and desirable solubility properties. In one embodiment, FGD gypsum products are engineered to maintain its integrity well past its initial contact with water, dissolving at a significantly slower rate that is more comparable to potash than to all other gypsum granules. This property is desirable and advantageous over the prior uses because this keeps the nutrients where they can be absorbed by the crop without creating unwanted run-off into watersheds.

Moreover, by removing a complete drying cycle and redundancies of running the gypsum through dryers at least twice in the manufacturing process (see dryer 102 and dryer 104 in FIG. 1), embodiments of the invention create a new streamlined process to produce pelletized gypsum with an improved solubility profile, without sacrificing granule integrity and/or crush strength.

### BRIEF DESCRIPTION OF THE DRAWINGS

FIG. 1 is an existing process for manufacturing gypsum pellets according to prior art.

FIG. 2 is a system for manufacturing gypsum pellets according to one embodiment of the invention.

FIG. 3 is a flow chart illustrating a process for manufacturing pelletized gypsum according to one embodiment of the invention.

FIG. 4 is an alternative system for manufacturing gypsum pellets according to one embodiment of the invention.

### DETAILED DESCRIPTION

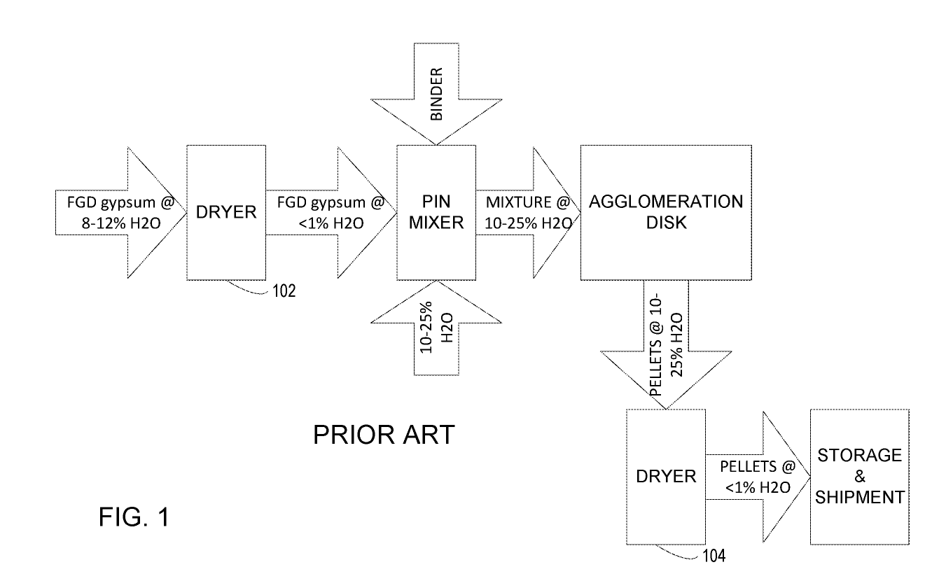

Aspects of the invention provide a more efficient process for manufacturing fertilizer granules from FGD gypsum. Other manufacturers have simply followed a process that mimics the manufacture of fertilizer granules from mined gypsum, such as those depicted in FIG. 1. In other words, they first dry the raw FGD gypsum from a moisture level of 8-12% to a moisture level of less than 1% in the first dryer 102. Then, the material is combined with additive binders to generate crush strength, usually in a pin mixer. The mixture is then rehydrated, sometimes to levels in excess of 20% before being fed into a forming device such as a pan agglomerator or extruder. The resulting pellets then must be dried again, in another dedicated dryer 104, from this high moisture level to a moisture level of less than 1% free moisture in a rotary dryer, fluid bed dryer or an oven.

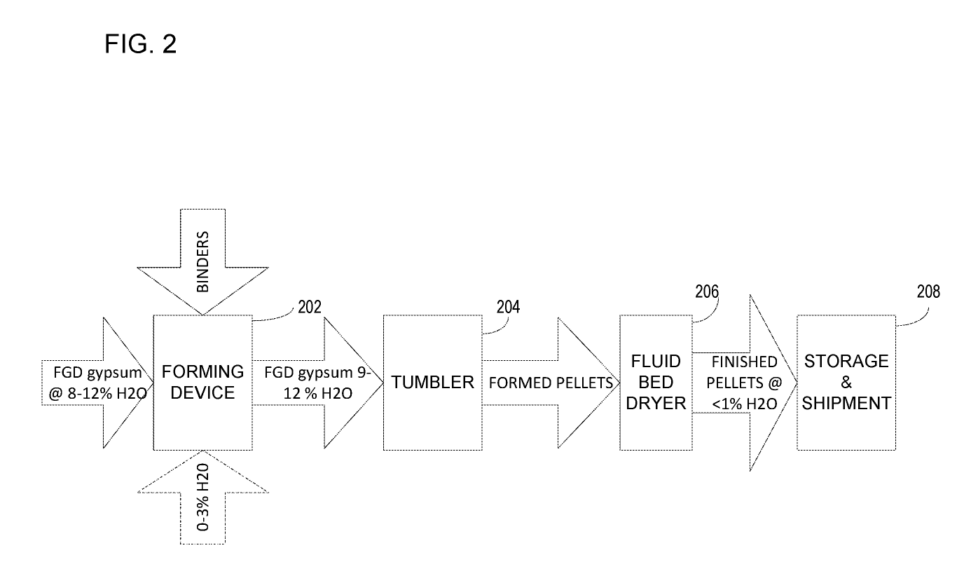

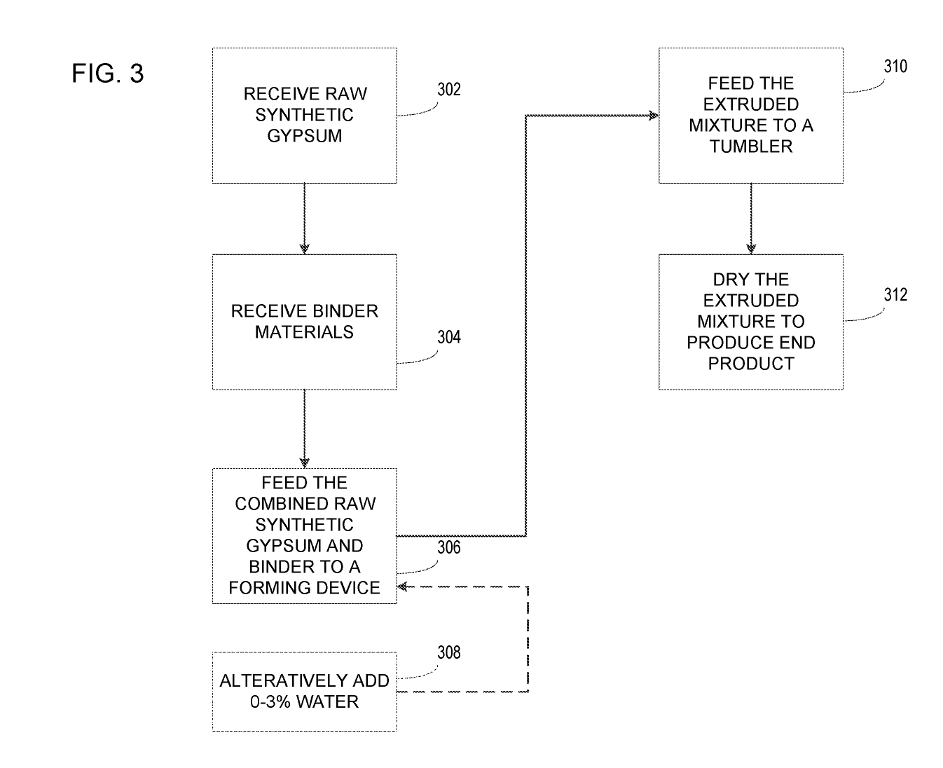

Referring now to FIG. 2 and FIG. 3, FIG. 2 illustrates a manufacturing process that saves money, gas and water according to one embodiment of the invention. FIG. 3 is an exemplary flow process for manufacturing the pelletized synthetic gypsum according to one embodiment of the invention. At 302, raw synthetic gypsum or FGD gypsum is received. In one example, the received raw synthetic gypsum includes about at 8-12% moisture. At 304, a binder material, such as a polysaccharide or biogum, is received. The combined substance, not yet being mixed, is fed into a forming device 202 at 306. In one example, the forming device 202 includes an extruder. In this embodiment, the forming device 202 both mixes the raw synthetic gypsum and the binder and extrudes the mixture. Aspects of the invention include this process such as to eliminate the need for the initial dryer, as the dryer 102 shown in FIG. 1.

In another embodiment, while it is desirable to receive the raw synthetic gypsum with a moisture content between 8-12%, if the synthetic gypsum's moisture content is at the low end of the moisture range, an alternative water inlet may be used to add slightly more water, at 308, such as 0-3%, to the process at this stage. On the other hand, if the synthetic gypsum's moisture content is toward the upper end of this range, the process in this embodiment recognizes the inherent moisture level and does not need any additional water to be added.

Once the pellets exit the extruder, the extruded mixture is fed to a tumbling drum, tumbler, or spheronizer 204 at 310 for 5-10 minutes. The tumbled mixture forms dense pellets for the drying step. In one embodiment, the tumbler 204 is connected to an inlet feeding dry, relatively cool air across the formed pellets to avoid calcination. In another embodiment, the formed pellets are fed to a dryer 206 to dry the formed pellets at 312. In one embodiment, the drying temperature may be at a temperature between about 150-190 degrees Fahrenheit for about 3 to 10 minutes. It is well understood at this stage that aspects of the invention provide a streamlined process that eliminates:

(a) the need to dry the material from 8-12% moisture to <1% moisture initially;

(b) the need to rehydrate the material to a higher moisture level;

(c) the need to utilize a separate mixer; and

(d) the need to dry the formed pellets from an excessive moisture level back to <1% in the final drying step.

After the drying process, the dried pellets are ready for storage and shipment 208. In one embodiment, the resulting or finished pellets include moisture content of less than 1% by weight.

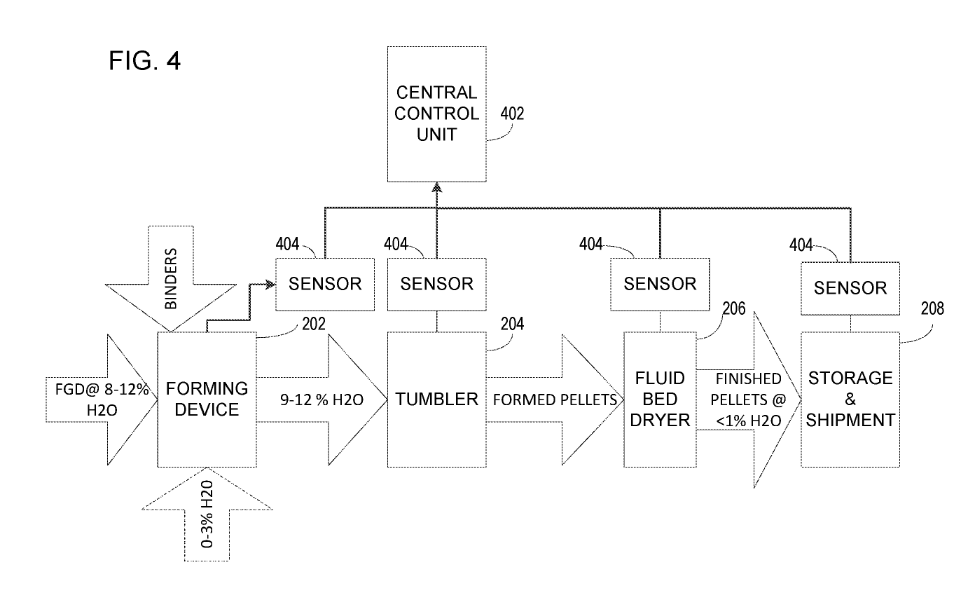

In another embodiment, FIG. 4 illustrates another system implementing aspects of the invention. In this embodiment, the forming device 202, the tumbler 204, the dryer 206 and the storage and shipment 208 may be connected to one or more digital sensors 404. These sensors 404 provide inputs to a central control unit 402. For example, the sensors 404 for the forming device 202 may provide moisture related data to the central control unit 402. Likewise, the sensors 404 for the tumbler 204 may provide data relating to time, speed of rotation of the tumbler 204, etc., to the central control unit 402. Moreover, the sensors 404 for the drier 206 may provide data such as weight or volume of the materials to be dried, temperature information throughout the drying process, etc., to the central control unit 402. The sensors 404 for the storage and shipment 208 may provide data such as time of product (manufacturing date and ship date), product batch serial number, etc., to the central control unit 402. In one embodiment, the central control unit 402 may be a computer device, such as a server, or a plurality of computing devices. The computer device or computing devices may include a processing unit, a memory accessible by the processing unit, and input/output connectivity system, and/or an interface. The central control unit 402 may be connected to the sensors 404 via a wired connection or a wireless connection via the input/output connectivity system. The central control unit 402 may further be connected with external devices such as other databases, servers, or end user devices such as personal computing devices, including but not limited to personal computers, mobile devices (tablets, smartphones, digital readers, smart watches, personalized tracking/alerting devices). The interface of the central control unit 402 may be configured to set various alerts or notifications to be provided to the users, either directly or through the connectivity to the other devices, such that the users may be notified in response to a triggering event. It is to be understood that other alerting capabilities or connectivity capabilities may be added to the central control unit 402 as part of a modernized and interconnected manufacturing system without departing from the scope or spirit of the aspects of the invention.

Aspects of the invention may be further fine-tuned or custom-configured without removing individual parts. In a second embodiment, in order to achieve or target solubility of the end product, the manufacturing process or flow may be conveniently and efficiently configured to effect a change or modification in the solubility profile of the gypsum granules. For example, powdered synthetic gypsum, as raw materials, may be mixed in a combination mixer/forming device with a polysaccharide binder such as guar gum, CMC or a corn starch, instead of using ammonium or calcium lignosulfonate to give their products form and durability. The primary measure of this durability is known as crush strength.

Manufacturers of pellets using mined gypsum tend to achieve a crush strength of 1.5-3.5 pounds per square inch. This is tested by placing pellets of a comparable size and using a force pressure gauge to measure that amount of force it takes to crush the pellet into dust. Higher crush strengths are preferred, as crush strengths below 3.0 psi are considered too soft for achieving sound fertilizer blends and application using modern impeller-based fertilizer spreaders. By using a higher rate of lignosulfonate, prior technology manufacturers of pelletized gypsum using synthetic gypsum are able to achieve crush strengths of 3.0-8.0 psi.

These firms compete on crush strength and price. But there is another axis of potential competition that has gone unexamined—relative solubility. Lignosulfonate does nothing to retard the dissolution of pelletized gypsum in the presence of water. If dropped into water, these pellets dissolve almost immediately. In simulated rainfall testing, it takes less than one-half of an inch of heavy rain to make these pellets disappear. Given that these pellets are spread in the spring and fall of the year, rainfall events greater than 0.5 inches are the rule, not the exception. How much of the sulfur in these pellets leaves the field as surface water runoff? How much of this sulfur bought by the farmer is wasted? Prior art fails to address these questions.

Aspects of the invention take a different approach. As illustrated above, the manufacturing process exemplified by embodiments of the invention begins with a forming device, such as an extruder, that tends to produce a denser, harder pellet than the standard agglomeration disk from the outset. The backpressure at the extruder's face plate, in one embodiment, may compress the gypsum and binder mixture sufficiently to reduce the voids in the formed pellets to allow for slower water absorption. In these embodiments, the formed pellets from the forming device are next tumbled aggressively to round them and to provide a source of secondary compaction. This two-staged compaction, without having a re-wetting process between two drying processes as in prior art, produces moisture absorbing characteristics desirable for optimal use of synthetic gypsum pellets as agricultural fertilizers.

As a result of the different approach to the manufacturing process, the focus of the binder search has been on an entirely new axis of competition—optimal solubility. By using a 0.5%-2.0% rate of a pre-gelled corn starch, inventors of the invention recognize it would increase the amount of simulated rainfall necessary to completely dissolve our agricultural grade pellets to 0.5-2.0 inches. This is comparable to potash and several other common commercial fertilizers, and it reduces nutrient loss due to runoff.

While the traditional axis of competition in the pelletized gypsum market has been durability, as measured by crush strength, embodiments of the invention have created an entirely new value proposition while simultaneously improving environmental and economic benefits. Instead of just searching for a way to keep the gypsum particles bound together long enough to get them to the field, aspects of the invention seek to change the fundamental properties of the gypsum itself by changing the way it behaves in the field. Embodiments of the invention create synthetic gypsum granules utilizing different polysaccharide binders that result in the dissolution profiles during simulated rainfall testing example shown below:

about 1.0% pre-gelled cornstarch shows it may require about 1.0 inches of heavy simulated rain;

about 1.0% dry guar gum powder may require about 0.5 inches of heavy simulated rain;

about 1.0% CMC powder may require about 2.0 inches of heavy simulated rain;

In another embodiment, as another example, using an industrial-sized equipment in an industry production, the dissolution profiles may be changed showing the following characteristics:

about 1.5% pre-gelled cornstarch shows it may require about 2.0 inches of heavy simulated rain, while smaller rates can dissolve in as little as about ½ inch of simulated rain;

about 1.0% dry guar gum powder may require about 0.75 inches of heavy simulated rain;

about 1.0% CMC powder may require about 3.0 inches of heavy simulated rain.

In other words, aspects of the invention may adjust or modify solubility and the dissolution profile may depend on calibration of backpressure, binder type, binder rate, and granule size. For example, after the inventor of embodiments of the invention recognizes the relationship and characteristics of the following, the percentage of the above may be modified or altered:

1. Lignin binders may dissolve immediately;

2. Guar binders may dissolve more slowly;

3. Starch binders may dissolve slower than guar binders; and

4. CMC binders may dissolve slower than starch binders.

According to another embodiment, the manufacturing process discussed herein may be calibrated to produce products tailored to fit low-moisture environments such as Kansas, Texas and Oklahoma. In laboratory trials, inventors of the invention discovered that a 1-5% solution of bentonite clay added to the binders above could accelerate the breakdown and increase the dispersion of the pellet once the moisture threshold was met and the pellet began to dissolve.

In a further embodiment of our invention, inventors further take the basic manufacturing process and reduce the amount of polysaccharide binder to 0.5% or less. With this adjustment, paper mill residue may be added to the mixture from 2-5% by weight. The result is no longer just delayed dissolution, but actual timed release. With this formulation, aspects of the invention may produce pellets for application in the spring will dissolve steadily with each rain, along with other mechanical and biological forces acting upon it. Sulfur and calcium will be released at a relatively steady rate across the growing season. We have successfully created a variety of formulations with nutrients that include zinc, boron and humic acid. We are also experimenting with the addition of urea into the extruder, which should have significant environmental advantages.

Sulfur and calcium are used by plants at a steady rate across the growing season, but nitrogen are used by crops like corn at varying rates depending on the plants' stage in life. But because it is difficult to apply nitrogen on more mature plants, over-application occurs early in the plant's life to increase the odds of having some left over when the plant needs it. Products produced above utilizing the properties of paper mill residue, embodiments of the invention could combine urea with gypsum to create a much more effective controlled-release fertilizer that reduces surface runoff and increases nitrogen availability when it's needed by the plant. Aspects of the invention may create a true timed-release product that may reduce over application early in the target crop's life cycle. This approach provides both economic benefits to the farmer and water quality benefits to the environment.

The process for manufacturing fertilizer granules from FGD gypsum according to aspects of the invention may be significantly more efficient than that used by other manufacturers. Other manufacturers dry the raw material from 7-12% moisture to <1% moisture, then rehydrating it back to as much as 20% moisture. To the contrary, embodiments of the invention use the moisture inherent in the raw material, which completely eliminates both the initial drying and rehydrating steps.

As described above and illustrated in the figures, manufacturing process of embodiments of the invention involves both extrusion and tumbling and produces a denser granule with inherently greater crush strength than comparable granules made on an agglomeration disk.

Moreover, formulations developed in the embodiments of the invention utilize polysaccharide binders such as pre-gelled starches and biogums that slow down the dissolution of our fertilizer granules in the presence of water. The rest of the industry is focused solely on crush strength.

Additionally, manufactured granules according to aspects of the invention contain micronutrients useful to crop nutrition such as zinc, boron or humates. In addition, another aspect of the invention includes a process to utilize paper mill residue to create a true timed-release product that should reduce over application early in the target crop's life cycle. As such, embodiments of the invention provide advantages over prior approaches by using 5-7 times less water than the current manufacturing process. At the same time, embodiments of the invention evaporate away (e.g., dry) as little as 9-12 percentage points of moisture, versus a total of 15-29 percentage points of moisture in the current manufacturing process. Further, embodiments of the invention have in-dwelling dryer times of 3-10 minutes at temperatures of 150 to 190-degrees Fahrenheit. The prior manufacturing process would require either longer in-dwelling time or higher temperatures.

Furthermore, granules produced according to embodiments of the invention with significantly lower binder use rates. The prior manufacturing process produces a less dense granule, necessitating lignin binding use rates of 4-8% by weight to keep the gypsum grains together. Our process uses binder use rates of 0.5-2.0% by weight.

After realizing such advantage, formulations on achieving optimum dissolution rates in the presence of water may be attainable based on embodiments of the invention. Internal tests on currently marketed gypsum fertilizer granules showed that they dissolved completely with 0.5-1.0″ of simulated rainfall. In the same tests, aspects of the invention dissolve in about 2.0-3.0 inches of simulated rainfall. Moreover, embodiments of the invention include a 1.0%-5.0% mixture of bentonite clay to increase the physical dispersion of the gypsum grains that make up the finished granules per a given amount of simulated rainfall.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions within the central control unit. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for producing pelletized synthetic gypsum with desirable solubility properties comprising:
a forming device for receiving a mixture of raw synthetic gypsum with about 8-12% of water by weight and a binder comprising at least polysaccharide or biogum, said forming device mixing and extruding the mixture, said mixed and extruded mixture comprising 9-12% of water by weight;
a tumbler for receiving the mixture for producing pellets; and
a dryer for receiving the pellets, said dryer removing moisture from the pellets, wherein the dried pellets comprise less than 1% water by weight.

2. The system of claim 1, wherein the binder is accompanied by micronutrients including zinc, boron or humates.

3. The system of claim 1, wherein the binder comprises paper mill residue to add a time-released property to the mixture.

4. The system of claim 1, wherein the binder is accompanied by one or more polymers or biological stimulants intended to enable the crop to utilize nutrients more efficiently.

5. The system of claim 1, wherein the dryer is configured to dry about 3 to 10 minutes at temperatures about 150 to 190 degrees Fahrenheit.

6. The system of claim 1, wherein the binder comprises about 1.0%-5.0% mixture of bentonite clay.

7. The system of claim 1, wherein the forming device further receives additional water at 0-3% by weight in response to having the raw synthetic gypsum with low water content level.

8. A manufacturing process for producing pelletized synthetic gypsum with desirable solubility properties comprising:
receiving a mixture of raw synthetic gypsum with about 8-12% of water by weight and a binder comprising at least one polysaccharide or biogum;
compacting in a first stage to produce pellets from a mixture of the raw synthetic gypsum and the binder, said pellets comprising 9-12% of water by weight;
compacting in a second stage, without adding water between the first stage and the second stage, the pellets in a tumbler to further compact the pellets; and
in response to receiving the pellets, drying the pellets to remove moisture from the pellets, wherein the dried pellets comprise less than about 1% water by weigh.

9. The manufacturing process of claim 8, further comprising receiving a dissolution profile, said dissolution profile specifying percentage values by weight of the following as a function amount of water in the form of simulated rainfall: lignin binders, guar binders, starch binders, and CMC binders.

10. The manufacturing process of claim 9, further comprising calibrating in the first stage or the second stage according to the dissolution profile.

11. A system for producing pelletized synthetic gypsum with desirable solubility properties comprising:
a forming device for receiving a mixture of raw synthetic gypsum with about 8-12% of water by weight and a binder comprising at least polysaccharide or biogum, said forming device mixing and extruding the mixture, said mixed and extruded mixture comprising 9-12% of water by weight;
a tumbler for receiving the mixture for producing pellets;
a dryer for receiving the pellets, said dryer removing moisture from the pellets, wherein the dried pellets comprise less than 1% water by weight; and
a central control unit for calibrating at least one of the following: the forming device, the tumbler, and the dryer, wherein the central control unit calibrates according to a dissolution profile.

12. The system of claim 11, wherein the binder is accompanied by micronutrients including zinc, boron or humates.

13. The system of claim 11, wherein the binder comprises paper mill residue to add a time-released property to the mixture.

14. The system of claim 11, wherein the binder is accompanied by one or more polymers or biological stimulants intended to enable the crop to utilize nutrients more efficiently.

15. The system of claim 11, wherein the dryer is configured to dry about 3 to 10 minutes at temperatures about 150 to 190 degrees Fahrenheit.

16. The system of claim 11, wherein the binder comprises about 1.0%-5.0% mixture of bentonite clay.

17. The system of claim 11, wherein the forming device further receives additional water at 0-3% by weight in response to having the raw synthetic gypsum with low water content level.

18. The system of claim 11, wherein the dissolution profile comprises percentage values by weight of the following as a function amount of water in the form of simulated rainfall: lignin binders, guar binders, starch binders, and CMC binders.
